(19) United States
(12) Patent Application Publication
(10) Pub. No.: US 2026/0304147 A1
(43) Pub. Date: Oct. 1, 2026

(54) ARTIFICIAL INTELLIGENCE (AI) BASED NETWORK MANAGEMENT

(71) Applicant: Rakuten Mobile, Inc., Tokyo (JP)

(72) Inventor: Tarek ZEID, Tokyo (JP)

(21) Appl. No.: 19/093,254

(22) Filed: Mar. 28, 2025

(51) Int. Cl. H04W 24/02; H04M 7/00

(52) U.S. Cl. CPC H04W 24/02; H04M 7/0081

(57) ABSTRACT

An Artificial Intelligence (AI) Model for an AI Based Network Management Device. To train the AI Model, network data is obtained. At least one input is received for processing by the Trained AI Model of the AI Based Network Management Device. The at least one input is processed using the Trained AI Model for the AI Based Network Management Device to identify a Network Management Issue. The Network Management Issue is automatically addressed using the Trained AI Model of the AI Based Network Management Device based on the processing the at least one input by the Trained AI Model of the AI Based Network Management Device. Information is provided as output to at least one user associated with the automatically addressed network management issue.

### FIELD

The present disclosure relates to Artificial Intelligence (AI) Based Network Management.

### BACKGROUND

The information disclosed in this background section is only for enhancement of understanding of the general background of the disclosure and should not be taken as an acknowledgement or any form of suggestion that this information forms the prior art already known to a person skilled in the art.

International business involves international roaming services, such as international voice and International SMS. These services apply to responses for the connectivity of mobile customers traveling outside borders of a predetermined geography, such as a country, and enable mobile customers to stay connected. The international business has several departments: business development, product management, engineering, operations, and software development.

The operations team involves proving operation for customers 24 by 7. To provide operation the operations team has to perform a lot of manual work. An operations team is able to include L1 and L2 engineers monitoring defined KPIs to determine whether an abnormal condition occurs that results in an alarm. The engineers who work at L1 have basic knowledge about the services and goods and can solve only fundamental issues and problems like resetting passwords and installing software. L2 handles more advanced tasks, including network configuration and security.

The L1 team performs testing in an associated destination where the problem happened, obtains traces, and raises the issue L2 engineering where L2 engineering is able to analyze the trace. The first point of contact for network issues is the L1 engineers that are primarily responsible for basic troubleshooting, monitoring network performance, and escalating complex problems to higher-level engineers. The L1 engineers are essentially the initial response team for network incidents within a Network Operations Center (NOC).

L2 engineers perform the investigation into the issue, create reports, and take corrective and preventive action.

### SUMMARY

In at least embodiment, a method includes at least one input is received for processing by a Trained AI Model of an AI Based Network Management Device. The at least one input is processed using the Trained AI Model for the AI Based Network Management Device to identify a Network Management Issue. Based on the processing the at least one input by the Trained AI Model of the AI Based Network Management Device, automatically addressing the Network Management Issue using the Trained AI Model of the AI Based Network Management Device. Information associated with the automatically addressed network management issue is provided to at least one user as output.

According to at least one embodiment, a system is configured to receive at least one input for processing by a Trained AI Model of an AI Based Network Management Device. The at least one input is processed using the Trained AI Model for the AI Based Network Management Device to identify a Network Management Issue. Based on the processing the at least one input by the Trained AI Model of the AI Based Network Management Device, the Network Management Issue are automatically addressed using the Trained AI Model of the AI Based Network Management Device. Information associated with the automatically addressed network management issue is provided to at least one user as output.

In at least one embodiment, a non-transitory computer-readable media having computer-readable instructions stored thereon, which when executed performs operations for receiving at least one input for processing by a Trained AI Model of an AI Based Network Management Device. The at least one input is processed using the Trained AI Model for the AI Based Network Management Device to identify a Network Management Issue. Based on the processing the at least one input by the Trained AI Model of the AI Based Network Management Device, the Network Management Issue is automatically addressed using the Trained AI Model of the AI Based Network Management Device. Information associated with the automatically addressed network management issue is provided to at least one user.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a schematic diagram of a mobile network according to at least one embodiment.

FIG. 2 is a schematic diagram of an Artificial Intelligence (AI) Based Network Management Device for providing management of a network according to at least one embodiment.

FIG. 3 is a diagram of a high level design for the AI Based Network Management Device according to at least one embodiment.

FIG. 4 is a diagram of VIP Network Monitoring & Quality Assurance performed according to at least one embodiment.

FIG. 5 is a diagram of Service Functionality, Quality Testing and Auto-Resolution performed according to at least one embodiment.

FIG. 6 is a diagram of a Network Configuration Health Check performed according to at least one embodiment.

FIG. 7 is a diagram of Network Capacity Prediction performed according to at least one embodiment.

FIG. 8 is a flowchart of a method for providing Artificial Intelligence (AI) Based Network Management according to at least one embodiment.

FIG. 9 is a block diagram of a device according to at least one embodiment.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flow chart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods described herein may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

Further, spatially relative terms, such as “beneath,” “below,” “lower,” “above,” “upper” and the like, are used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus is otherwise oriented (rotated 90 degrees or at other orientations) and the spatially relative descriptors used herein likewise are interpreted accordingly.

The following disclosure provides illustration and description but is not intended to be exhaustive or to limit the implementations to the precise form disclosed. Modifications and variations are possible in light of the above disclosure or may be acquired from practice of the implementations.

According to at least one embodiment, an artificial intelligence (AI) based device for management of a network is provided. The AI Based Network Management Device provides an AI Model that is trained to perform AI Based Network Management. At least one input is received for processing by a Trained AI Model of an AI Based Network Management Device. The at least one input is processed using the Trained AI Model for the AI Based Network Management Device to identify a Network Management Issue. Based on the processing the at least one input by the Trained AI Model of the AI Based Network Management Device, automatically addressing the Network Management Issue using the Trained AI Model of the AI Based Network Management Device. Information associated with the automatically addressed network management issue is provided to at least one user as output. The management of the network includes monitoring and analysis of International Roaming (IR) Key Performance Indicator (KPI) which measures the quality of service a mobile network user experiences in response to a user roaming on another network, e.g., in a different country. The AI Based Network Management Device is able to focus on metrics such as call setup success rate, dropped call rate, data connection quality, and overall network accessibility while roaming. In at least one embodiment, the AI Based Network Management Device automates IR tasks traditionally performed by international roaming engineers, thereby improving operational efficiency and resource optimization. In at least one embodiment, the AI Based Network Management Device performs testing, KPI measurement, comparison with benchmarks, troubleshooting, and ticket management. In at least one embodiment, the AI Based Network Management Device is usable for supporting other aspects of the business.

Embodiments described herein describe a method that provides one or more advantages. For example, the AI Based Network Management Device automates international roaming tasks. The AI Based Network Management Device automatically monitors and detects international roaming events. The AI Based Network Management Device receives input, such as user prompts and signaling obtained from the network. Based on the input, the AI Based Network Management Device then provides as output a response from a Chatbot. Other information provided as output includes VoIP communications, email messages, and ticketing.

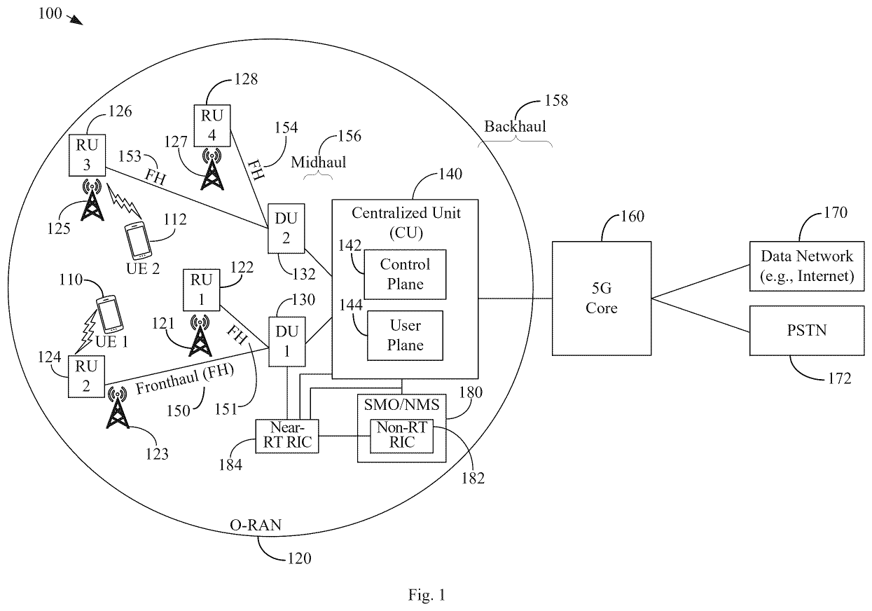

FIG. 1 is a schematic diagram of a mobile network 100 according to at least one embodiment.

In FIG. 1, UE 1 (User Equipment 1) 110 and UE 2 112 access Mobile Network 100 via a Radio Access Network 120.

Radio Access Network 120 includes Radio Towers 121, 123, 125, and 127. Radio Towers 121, 123, 125, 127 are associated with RU (Radio Unit) 1 122, RU 2 124, RU 3 126, and RU 4 128, respectively.

RU 1 122, RU 2 124, RU 3 126, RU 4 128 handle the Digital Front End (DFE) and the parts of the PHY layer, as well as the digital beamforming functionality. RU 1 122 and RU 2 124 are associated with Distributed Unit (DU) 1 130, and RU 3 126 and RU 4 128 are associated with DU 2 132. DU 1 130 and DU 2 132 are responsible for real time Layer 1 and Layer 2 scheduling functions. For example, in 5G, Layer-1 is the Physical Layer, Layer-2 includes the Media Access Control (MAC), Radio link control (RLC), and Packet Data Convergence Protocol (PDCP) layers, and Layer-3 (Network Layer) is the Radio Resource Control (RRC) layer. Layer 2 is the data link or protocol layer that defines how data packets are encoded and decoded, how data is to be transferred between adjacent network nodes. Layer 3 is the network routing layer and defines how data moves across the physical network.

DU 1 130 is coupled to the RU 1 122 and RU 2 124, and DU 2 132 is coupled to RU 3 126 and RU 4 128. DU 1 130 and DU 2 132 run the RLC, MAC, and parts of the PHY layer. DU 1 130 and DU 2 132 include a subset of the eNB/gNB functions, depending on the functional split option, and operation of DU 1 130 and DU 2 132 are controlled by Centralized Unit (CU) 140. CU 140 is responsible for non-real time, higher L2 and L3. Server and relevant software for CU 140 is able to be hosted at a site or is able to be hosted in an edge cloud (datacenter or central office) depending on transport availability and the interface for the Fronthaul connections 150, 151, 153, 154. The server and relevant software of CU 140 are also able to be co-located at DU 1 130 or DU 2 132, or is able to be hosted in a regional cloud data center.

CU 140 handles the RRC and PDCP layers. The gNB includes CU 140 and one or more DUs, e.g., DU 1 130, connected to CU 140 via Fs-C and Fs-U interfaces for a Control Plane (CP) 142 and User Plane (UP) 144, respectively. CU 140 with multiple DUs, e.g., DU 1 130, and DU 2 132, support multiple gNBs. The split architecture enables a 5G network to utilize different distribution of protocol stacks between CU 140, and DU 1 130 and DU 2 132, depending on network design and availability of the Midhaul 156. While two connections are shown between CU 140 and DU 1 130 and DU 2 132, CU 140 is able to implement additional connections to other DUs. CU 150, in 5G, is able to implement, for example, 256 endpoints or DUs. CU 140 supports the gNB functions such as transfer of user data, mobility control, RAN sharing (MORAN), positioning, session management, etc. However, one or more functions are able to be allocated to the DU. CU 140 controls the operation of DU 130 and DU 132 over the Midhaul interface 156.

Backhaul 158 connects the 4G/5G Core 160 to the CU 140. Core 160 may be, for example, up to 200 km away from the CU 140. Core 160 provides access to voice and data networks, such as Internet 170 and Public Switched Telephone Network (PSTN) 172.

RAN 120 is able to implement beamforming that allows for directional transmission or reception. 5G beamforming enables 5G connections to be more focused toward a receiving device. RAN 120 is also able to implement MIMO (Multiple Input Multiple Output), including mMIMO (massive MIMO), to provide an increase in throughput and signal-to-noise ratio (SNR). MIMO improves the radio link by using the multiple paths over which signals travel from the transmitter to the receiver. The multiple paths are de-correlated, and this provides the opportunity to send multiple data streams over them.

Massive MIMO and dense small cell deployments are being implemented to improve radio resource efficiency. However, the intra-cell interference from neighboring cells presents a serious problem. According to at least one embodiment, the modeling of interference patterns in a Massive MIMO deployment is used to identify interfering beams between different sectors so that interference optimization techniques are able to be applied to address interference.

A Service Management and Orchestration (SMO)/NMS 180 oversees the orchestration aspects, and the management and automation of RAN elements. SMO 180 supports O1, A1 and O2 interfaces. Non-RT RIC (non-Real-Time RAN Intelligent Controller) 182 enables non-real-time control and optimization of RAN elements and resources, AI/ML workflow including model training and updates, and policy-based guidance of applications/features in Near-RT RIC 184. Near-RT RIC 184 enables near-real-time control and optimization of O-RAN elements and resources via fine-grained data collection and actions over the E2 interface. Near-RT RIC 184 includes interpretation and enforcement of policies from Non-RT RIC 182, and supports enrichment information to optimize control function.

Near-RT RIC 184 obtains information associated with the beams that are passed to Non-RT RIC 182 and processed, for example, by an rApp at the Non-RT RIC 184, to generate an interference matrix. xApps are hosted on the Near-RT RIC 184 and are able to be used to optimize radio spectrum efficiency. rApps are specialized microservices operating on the Non-RT RIC 184. xApps and rApps provide control and management features and functionality.

While an O-RAN 120 is shown in FIG. 1, embodiments described herein are applicable to O-RANs and Virtualized RANs (vRANs). O-RAN and vRAN disaggregate RAN hardware into three modules or functions, e.g., Radio Units (RUs) 122, 124, 126, 128, Distributed Units (DUs) 130, 132, and Centralized Units (CUs) 140. The software for these functions is decoupled from the purpose-built hardware and runs on standardized, common off-the-shelf (COTS) hardware. O-RAN 120 further opens the software interfaces between radios and other network elements, whereas the interfaces between components in vRAN are still primarily based on closed or proprietary interfaces. A RAN Intelligent Controller (RIC) including Non-RT RIC 182 and RT RIC 184, is also able to be integrated with Multi-Access Edge Cloud (MEC) and vRAN. Herein, Radio Nodes refers to RUs 122, 124, 126, 128, Dus 130, 132, and CUs 140. According to at least one embodiment, Artificial Intelligence (AI) Based Network Management Device is used for automating network monitoring, diagnosis, and action.

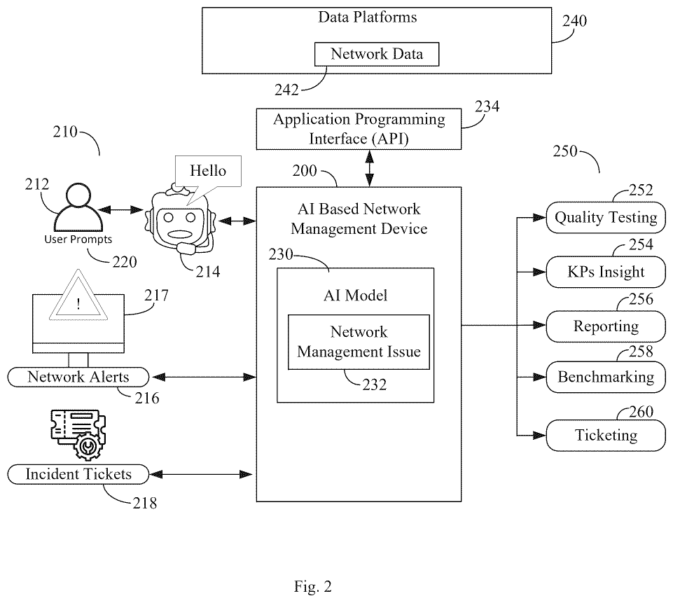

FIG. 2 is a schematic diagram of an Artificial Intelligence (AI) Based Network Management Device 300 for providing management of a network according to at least one embodiment.

In FIG. 2, an AI Based Network Management Device 200 is shown with inputs 210 and outputs 250. The AI Based Network Management Device 200 is also connected to a Data Platform 240. At least one Input 210 include user prompts 212 (e.g., Testing, Troubleshooting, Monitoring, Ticket Raising, etc.) that are provided to a Chatbot 214 of the AI Based Network Management Device 200, network alerts 216 that are communicated to the AI Based Network Management Device 200, and incident tickets 218 that are generated and communicated to the AI Based Network Management Device 200. For example, the network alerts 216 include KPI Alerts, Degradation, or Network Incident notices, as well as VIP Roaming Landing Notification, and the like.

At least one input 210 is received for processing by a Trained AI Model 230 of the AI Based Network Management Device 200. The at least one input 210 includes a verbal prompt 220 provided by a user 212 to the Chatbot 214 of the AI Based Network Management Device 200, and data 217 received from systems implemented for monitoring the network. The at least one input 210 is processed using the Trained AI Model 230 for the AI Based Network Management Device 200 to identify a Network Management Issue 232. The Network Management Issue 232 is automatically addressed using the Trained AI Model 230 of the AI Based Network Management Device 200 based on the processing the at least one input 210 by the Trained AI Model 230 of the AI Based Network Management Device 200.

Automatically addressing a Network Management Issue 232 is able to include, but is not limited to, parsing alarms and attempting auto-resolution of KPI deviations, detecting network degradation, detecting VIP personal have traveled to another network area (e.g., in another country) and ensuring network quality for the VIPs, performing continuous benchmarking of network KPIs against predetermined wireless standards and making adjustments to provide a level of service functionality and quality, correction network misconfigurations to prevent service disruption, predicting network congestion and recommending capacity upgrades before network degradation occurs, proactively scaling resources based on usage trends, and the like. Thus, Network Management Issues 232 involve problems that impact the configuration, performance and functionality of a network. Network Management Issues 232 are automatically addressed using the Trained AI Model 230 of the AI Based Network Management Device 200.

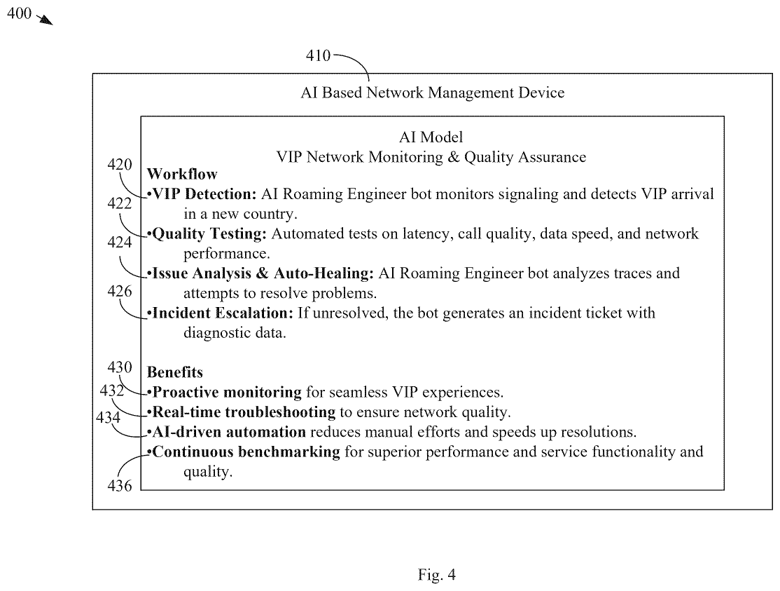

For example, to automatically address Network Management Issues 232, the Trained AI Model 230 of the AI Based Network Management Device 200 identifies which KPI metric is experiencing degradation, such as increased latency, high packet loss, or low throughput, and then pinpoints the specific network segment or device where the performance issue is occurring. A ticket is generated by the Trained AI Model 230 of the AI Based Network Management Device 200 to replace failing network devices or upgrade to higher capacity hardware if necessary. The Trained AI Model 230 of the AI Based Network Management Device 200 is able to make configuration adjustments such as optimizing network settings like routing protocols, Quality of Service (QoS) policies, bandwidth allocation, and the like. Traffic management is able to be implemented, such as implementing traffic prioritization mechanisms to manage high-priority data flows. Examples of at least some embodiments of Network Management Issues 232 are discussed in the use cases described with reference to FIGS. 4-7. However, a person having ordinary skill in the art understands that other uses cases and Network Management Issues 232 are able to be automatically addressed by the Trained AI Model 230 of the AI Based Network Management Device 200.

The AI Based Network Management Device 200 performs analysis including Input Processing and Context Management, Decision Making and Action Execution, Response Generation, Communication with the User, and the like. Actions of the AI Based Network Management Device 200 include Data Retrieval and Analysis, Automated Testing, Troubleshooting and Diagnostics, Notification and Alerts, Ticket Management, and the like.

The AI Based Network Management Device 200 provides at least one output 250. The at least one output 250 includes Quality Testing 252, KPI Insights 254, Reports 256 providing outcome summaries from actions taken by the AI Based Network Management Device 200, Benchmarking and Decision Support 258, and Incident Ticketing 260. Thus, information is provided as output 250 to at least one user associated with the automatically addressed Network Management Issue 232. The information provided as output 250 is able to include verbal output to a user via a chatbot of the AI Based Network Management Device 200, and test results, tracing outcomes, identification of anomalies, benchmarking, ticketing of issues, and reports.

The AI Model 230 is trained using data and as new data is provided to the AI Based Network Management Device 200 continuous learning and improvement occurs. The AI Model 230 is provided for an AI Based Network Management Device 200. Network Data 242 is provided to The AI Model 230 to train the AI Model 230. The Network Data 242 is provided using data stored in a Data Platform 240.

The AI Based Network Management Device 200 includes an Application Programming Interface (API) 234 for enabling the AI Based Network Management Device 200 to communicate with the Data Platform 240.

Accordingly, the AI Based Network Management Device 200 automates International Roaming (IR) tasks traditionally performed by international roaming engineers, improves operational efficiency and resource optimization. The AI Based Network Management Device 200 performs Testing 252, KPI Measurement 254, Reporting 256, Benchmarking 256, e.g., comparison with benchmarks and troubleshooting, and Ticketing 260, e.g., ticket management. Instead of having 10-20 people monitoring and performing analytics for the engineering and investigation, reading the traces and performing testing, the AI Based Network Management Device 200 is used. The AI Based Network Management Device 200 is able to learn to perform the functions involved in the management of the network.

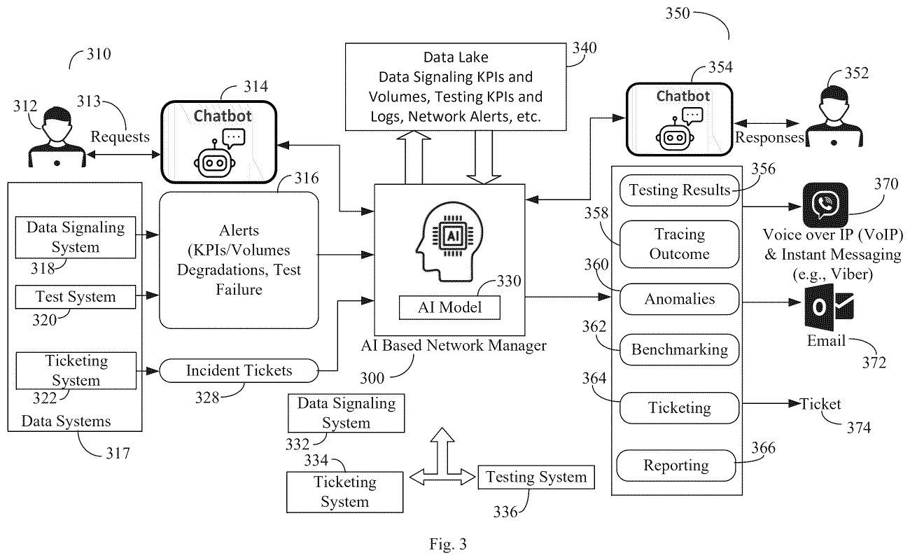

FIG. 3 is a diagram of a high level design for the AI Based Network Management Device 300 according to at least one embodiment.

The AI Based Network Management Device 300 provides the processing of inputs 310 and generates outputs 350. Inputs 310 include users'input, and systems input. For example, a user 312 is able to make Requests 313 to a Chatbot 314, wherein the Chatbot 314 communicates Requests 313 from the user 312 to the AI Based Network Management Device 300. Data is fed from Data Systems 317 to the AI Based Network Management Device 300. Data Systems 317 feeds data from one or more systems, such as from one or more Data Signaling Systems 318, data from one or more Testing Systems 320, data (e.g., ticketing) from one or more Ticketing Systems 322, and the like. Alerts 316 (e.g., KPIs/Volumes Degradations, Test Failure, and the like) are received from one or more systems, such as from one or more of Data Signaling System 318, Test System 320, and the like. One or more Ticketing Systems 322, and the like generate Incident Tickets 328 that are provided to the AI Based Network Management Device 300.

Data Signaling Systems 318 provides Tracing and Troubleshooting, KPI Alerts and Deviations, and the like. One or more Ticketing Systems 322 provides Ticket Management, Node KPIs Monitoring, and the like. One or more Testing Systems 320 provides Quality Testing, Reporting and Alerting, VIP Roaming Testing, and the like.

The AI Based Network Management Device 300 is able to access a Data Lake 340 to access stored Data Signaling KPIs and Volumes, Testing KPIs, and Logs, Network Alerts, and the like. The AI Based Network Management Device 300 provides responses as output 350 to a user 352 through a Chatbot 354. The AI Based Network Management Device 300 also provides outputs 350 that include Testing Results 356, Tracing Outcomes 358, Identification of Anomalies 360, Benchmarking 362, Ticketing 364, Reporting 366, and the like.

To learn to perform the functions involved in the management of the network, information related to the operation of the network is injected into the AI Model 330 of the AI Based Network Management Device 300.

Global roaming quality (GRG) standards define parameters for the international roaming and interconnection. The AI Based Network Management Device 300, according to at least one embodiment, is able to be integrated in different nodes. The AI Based Network Management Device 300 according to at least one embodiment like is able to read the signaling messages and connect with a ticketing system to generate the tickets associated with issues or problems in the network determined by the AI Based Network Management Device 300.

The AI Based Network Management Device 300 is also able to monitor the signaling of the international roaming and interconnect and in response to identifying the occurrence of a problem, the AI Based Network Management Device 300 detects the problem and immediately performs testing using a testing tool integrated with the AI Based Network Management Device 300.

The AI Based Network Management Device 300 reads the signaling traces from the testing and from the live traces. The AI Based Network Management Device 300 creates reports 366 and takes action to fix a problem. In response to the AI Based Network Management Device 300 not being able to fix the problem automatically, the AI Based Network Management Device 300 provides details of the problem to an engineer for human intervention for addressing the problem. Thus, the AI Model 330 of the AI Based Network Management Device 300 is well educated about the information and the knowledge related to this business.

International Business monitor international roaming. For mobile operators, only 500 to 1000 work in international roaming. The AI Based Network Management Device 300, according to at least one embodiment, is configured to replace the human engineers that perform such monitoring and that perform the analytics. The AI Based Network Management Device 300 learns how to perform the analysis and the tracing. The AI Based Network Management Device 300 raises the issues to the engineers to have a case in front of them and identify the action that the engineer needs to perform. The AI Model 330 of the AI Based Network Management Device 300 continues to learn and transitions from having the expertise of a junior engineer to having the expertise of a senior engineer as the AI Based Network Management Device 300 gains experience.

According to at least one embodiment, the AI Based Network Management Device 300 is centrally located, e.g., in a server on the backend of the network. However, by addressing legal and regulatory issues, the AI Based Network Management Device 300 is able to be implemented in different nodes within a company, e.g., network nodes, incident tickets node, testing solutions, and so on.

Network nodes to read the signaling messages of the customers, and testing solutions are able to be used to remotely conduct testing in different destinations worldwide and produce Testing Results 356. Through the signaling and the testing solutions, the AI Based Network Management Device 300 is able to generate alarms. For example, a list of VIPs is maintained. Whenever the VIPs travel anywhere a trigger is generated. In this destination, immediately the AI will conduct some testing in this destination to make sure the quality is acceptable.

Performance indicators, such as voice, data, SMS, are monitored to ensure everything is working properly. The output of the monitored performance indicators is compared to Global Roaming Quality (GRQ) standards to determine whether there are any problems. In response to there not being any problems, a flag is generated indicating that everything meets the GRQ standards. In addition, there are inputs for the creation of Incident Tickets 364. Any problems that are detected or any incident that needs to be to have a ticket open to a certain team is generated.

One or more systems are connected to a Data Lake 340. The AI Based Network Management Device 300 manages the Data Lake and the performance indicators for different nodes in the network. The advantage is that instead of connecting to or integrating with one or more of the systems one-by-one, the systems are integrated to the Data Lake 340. Other Solutions for signaling monitoring are used, such as one or more of Data Signaling System 332, Ticketing System 334, Testing System 336, and the like are also involved. KPIs reads are able to be analyzed.

Instead of using such systems manually, the AI Based Network Management Device 300 is able to automatically conduct the testing. A Chatbot 354 is also provided as an output 350. The Chatbot 354 simulates speaking with an engineer. In at least one embodiment, an avatar is provided to represent an engineer. The engineer includes a job description and starts as a junior engineer. However, within a period of time, the junior engineer will become a senior engineer because the AI Model 330 will learn and advance to a higher level of support. Thus, the outputs 350 include the Test Results 356, and the Tracing Outcome 358. The AI Based Network Management Device 300 is also able to perform Benchmarking 362, Ticketing 364, and Reporting 366. The Chatbot 354 is able to be provided using different systems. For example, the Chatbot 354 is able to be built on a Collaboration Application, such as Microsoft Teams, and the like. A Voice over IP (VoIP) and Instant Messaging Application 370 with cross-platform capabilities allow users to exchange audio and video calls, stickers, group chats, and instant voice and video messages, e.g., Viber, and the like. However, other applications may be integrated with the Chatbot 354. Outputs 350 also include email 372 and Ticket System 374.

Signaling is able to be read in terms of KPIs or in terms of error of messages, and in terms of messages going back and forth. In response to a messaging indicating an error that exceeds a specific threshold, a problem is determined to exist. So immediately, the AI Based Network Management Device 300 is able to detect, analyze, understand the root cause for the error, and take the action. The AI Based Network Management Device 300 is able to expand to not only cover the engineering part, but also to cover the commercial part, such as automating manual tasks used currently wherein roaming managers deal with mobile operators that are involved with tasks on the commercial side.

FIG. 4 is a diagram of VIP Network Monitoring & Quality Assurance 400 performed according to at least one embodiment.

In FIG. 4, The AI based Network Management Device 410 continuously monitors network signaling to detect when a VIP lands in any country 420. The AI based Network Management Device 410 then triggers automated service quality tests, benchmarks results, and ensures optimal performance. If an issue is found, the bot analyzes traces and attempts to fix it. If unresolved, it automatically creates an incident ticket for the relevant team.

The first step in the Workflow is for VIP Detection 420. The AI Based Network Management Device 410 monitors signaling and detects VIP arrival in a new country or other geographic location. Next, the AI Based Network Management Device 410 performs Quality Testing 422. Automated tests on latency, call quality, data speed, and network performance are performed. Issue Analysis and Auto-Healing 424 is performed. The AI Based Network Management Device 410 analyzes traces and attempts to resolve problems. Then, Incident Escalation 426 is performed. If unresolved, the AI Based Network Management Device 410 generates an incident ticket with diagnostic data.

Some of the benefits of the VIP detection performed by the AI Based Network Management Device 410 include Proactive Monitoring 430 for seamless VIP experiences, Real-Time Troubleshooting 432 to ensure network quality, AI-Driven Automation 434 that reduces manual efforts and speeds up resolutions, and Continuous Benchmarking 436 for superior performance and service functionality and quality.

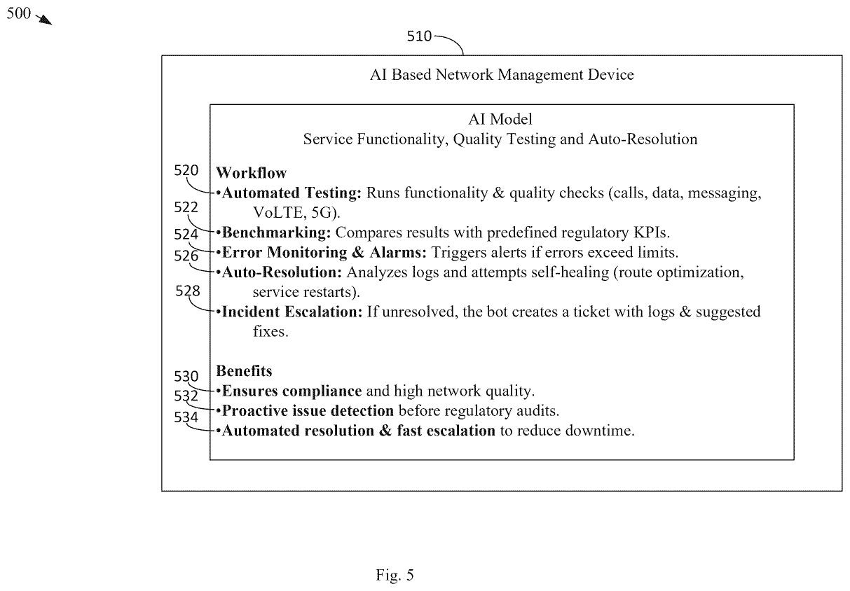

FIG. 5 is a diagram of Service Functionality, Quality Testing and Auto-Resolution 500 performed according to at least one embodiment.

In FIG. 5, the AI Based Network Management Device 510 performs automated service functionality and quality testing, benchmarks result against standard KPIs, and monitors errors. In response to errors exceeding certain thresholds, the AI Based Network Management Device 510 raises an alarm, attempts auto-resolution, and escalates to the relevant teams in response to being unresolved.

The first step in the Workflow is for Automated Testing 520. The AI Based Network Management Device 510 runs functionality & quality checks (calls, data, messaging, VoLTE, 5G). Next, the AI Based Network Management Device 510 performs Benchmarking 522 by comparing results with predefined regulatory KPIs. The AI Based Network Management Device 510 then performs Error Monitoring & Alarms 524 by triggering alerts in response to errors exceeding limits. Next, the AI Based Network Management Device 510 executes Auto-Resolution 526 by analyzing logs and attempts self-healing (route optimization, service restarts). Next, the AI Based Network Management Device 510 performs Incident Escalation 528 in response to issues being unresolved. The AI Based Network Management Device 510 creates a ticket with logs and suggested fixes.

Some of the benefits of the Service Functionality, Quality Testing and Auto-Resolution scenario include Ensuring Compliance 530 with standards and high network quality. Further advantages include Proactive Issue Detection 532 before regulatory audits, and Automated Resolution And Fast Escalation 534 to reduce downtime.

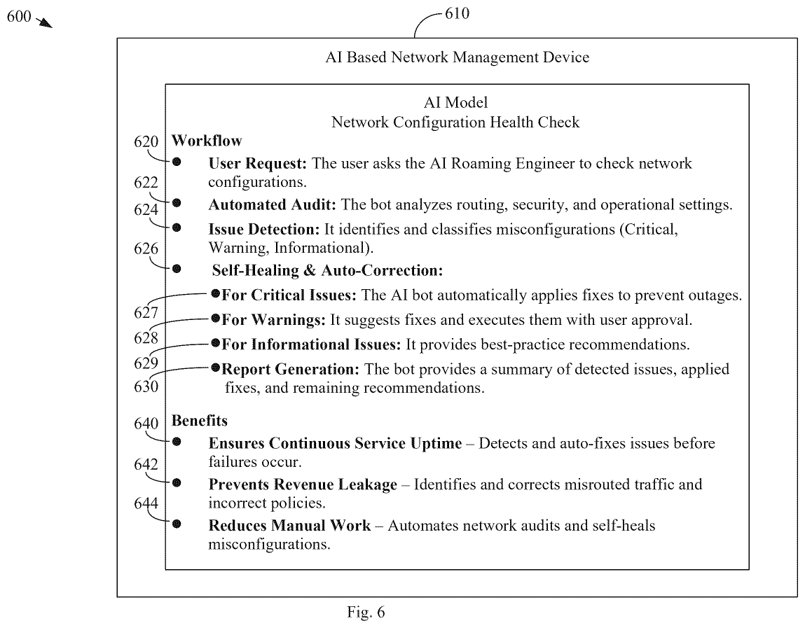

FIG. 6 is a diagram of a Network Configuration Health Check 600 performed according to at least one embodiment.

In FIG. 6, the AI Based Network Management Device 610 automates network configuration health checks, identifying and auto-correcting network misconfigurations to prevent service disruptions and revenue leakage. The AI Based Network Management Device 610 ensures network stability, security, and compliance while reducing manual effort through self-healing capabilities.

The first step in the Workflow is for handling User Request 620. The user asks the AI Based Network Management Device 610 to check network configurations. The AI Based Network Management Device 610 then performs an Automated Audit 622 by analyzing routing, security, and operational settings. Next, the AI Based Network Management Device 610 performs Issue Detection 624. The AI Based Network Management Device 610 identifies and classifies misconfigurations (Critical, Warning, Informational). The AI Based Network Management Device 610 performs Self-Healing & Auto-Correction 626. For Critical Issues 627, the AI Based Network Management Device 610 automatically applies fixes to prevent outages. For Warnings 628, the AI Based Network Management Device 610 suggests fixes and executes suggested fixes with user approval.

For Informational Issues 629, the AI Based Network Management Device 610 provides best-practice recommendations. Then, the AI Based Network Management Device 610 performs Report Generation 630. The AI Based Network Management Device 610 provides a summary of detected issues, applied fixes, and remaining recommendations.

Some of the benefits and advantages of the Network Configuration Health Check performed by the AI Based Network Management Device 610 include Ensuring Continuous Service Uptime 640. The AI Based Network Management Device 610 performs checks by detecting and auto-fixing issues before failures occur. The AI Based Network Management Device 610 also Prevents Revenue Leakage 642 by identifying and correcting misrouted traffic and incorrect policies, and Reduces Manual Work 644 by automating network audits and self-heals misconfigurations.

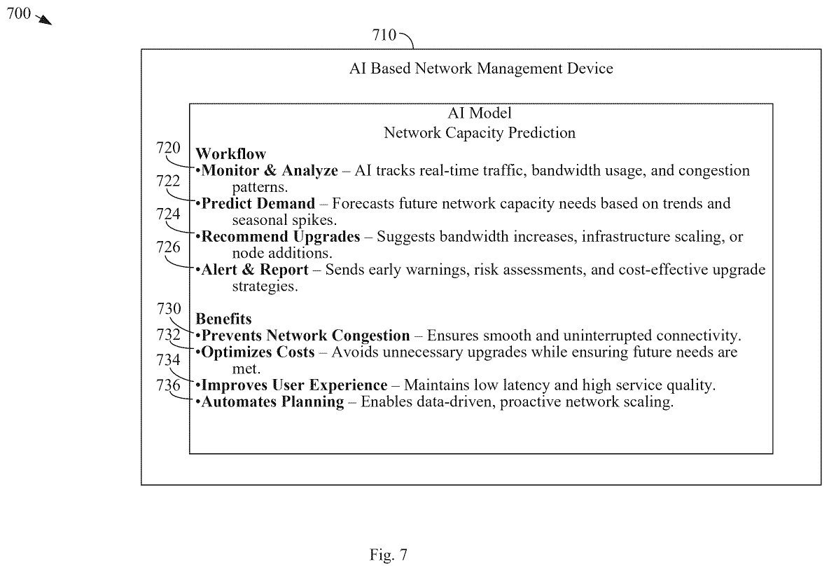

FIG. 7 is a diagram of Network Capacity Prediction 700 performed according to at least one embodiment.

The AI Based Network Management Device 710 monitors network traffic, predicts congestion, and recommends capacity upgrades before issues arise. The AI Based Network Management Device 710 ensures optimal network performance by proactively scaling resources based on usage trends.

First, the AI Based Network Management Device 710 performs Monitoring and Analysis 720 by tracking real-time traffic, bandwidth usage, and congestion patterns. The AI Based Network Management Device 710 then Predicts Demand 722. The AI Based Network Management Device 710 forecasts future network capacity needs based on trends and seasonal spikes. The AI Based Network Management Device 710 then Recommends Upgrades 724 by suggesting bandwidth increases, infrastructure scaling, or node additions. Next, the AI Based Network Management Device 710 generates Alerts & Reports 726 by sending early warnings, risk assessments, and cost-effective upgrade strategies.

Some of the advantages of the Network Capacity Prediction include Preventing Network Congestion 730 by ensuring smooth and uninterrupted connectivity, Optimizing Costs 732 by avoiding unnecessary upgrades while ensuring future needs are met, Improving User Experience 734 by maintaining low latency and high service quality, and Automating Planning 736 by enabling data-driven, proactive network scaling.

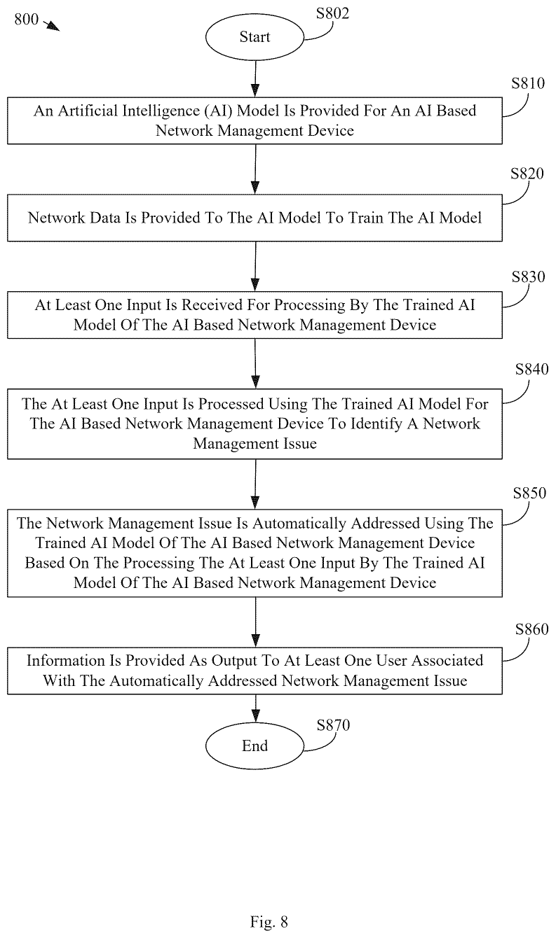

FIG. 8 is a flowchart 800 of a method for providing Artificial Intelligence (AI) Based Network Management according to at least one embodiment.

In FIG. 8, an Artificial Intelligence (AI) Model is provided for an AI Based Network Management Device S810. Referring to FIG. 2, at least one input 210 is received for processing by a Trained AI Model 230 of the AI Based Network Management Device 200.

Network Data is provided to The AI Model to train the AI Model S820. Referring to FIG. 2, the AI Model 230 is trained using data and as new data is provided to the AI Based Network Management Device 200 continuous learning and improvement occurs. The AI Model 230 is provided for an AI Based Network Management Device 200. Network Data 242 is provided to The AI Model 230 to train the AI Model 230. The Network Data 242 is provided using data stored in a Data Platform 240.

At least one input is received for processing by the Trained AI Model of the AI Based Network Management Device S830. Referring to FIG. 2, at least one input 210 includes a verbal prompt 220 provided by a user 212 to the Chatbot 214 of the AI Based Network Management Device 200, and data 217 received from systems implemented for monitoring the network. The at least one input 210 is processed using the Trained AI Model 230 for the AI Based Network Management Device 200 to identify a Network Management Issue 232.

The receiving the at least one input includes receiving a verbal prompt provided by a user to a chatbot of the AI Based Network Management Device. The receiving the at least one input includes receiving data from systems implemented for monitoring the network. Referring to FIG. 2, the at least one input 210 includes a verbal prompt 220 provided by a user 212 to the Chatbot 214 of the AI Based Network Management Device 200, and data 217 received from systems implemented for monitoring the network.

The at least one input is processed using the Trained AI Model for the AI Based Network Management Device to identify a Network Management Issue S840. Referring to FIG. 2, the at least one input 210 is processed using the Trained AI Model 230 for the AI Based Network Management Device 200 to identify a Network Management Issue 232. The Network Management Issue 232 is automatically addressed using the Trained AI Model 230 of the AI Based Network Management Device 200 based on the processing the at least one input 210 by the Trained AI Model 230 of the AI Based Network Management Device 200.

The Network Management Issue is automatically addressed using the Trained AI Model of the AI Based Network Management Device based on the processing the at least one input by the Trained AI Model of the AI Based Network Management Device S850. Referring to FIG. 2, the at least one input 210 is processed using the Trained AI Model 230 for the AI Based Network Management Device 200 to identify a Network Management Issue 232. The Network Management Issue 232 is automatically addressed using the Trained AI Model 230 of the AI Based Network Management Device 200 based on the processing the at least one input 210 by the Trained AI Model 230 of the AI Based Network Management Device 200.

Information is provided as output to at least one user associated with the automatically addressed network management issue S860. Referring to FIG. 2, information is provided as output 250 to at least one user associated with the automatically addressed Network Management Issue 232.

The information provided as output includes verbal output to a user via a chatbot of the AI Based Network Device. The information provided as output includes test results, tracing outcomes, identification of anomalies, benchmarking, ticketing of issues, and reports. Referring to FIG. 2, the information provided as output 250 is able to include verbal output to a user via a chatbot of the AI Based Network Management Device 200, and test results, tracing outcomes, identification of anomalies, benchmarking, ticketing of issues, and reports.

The process then terminates 870.

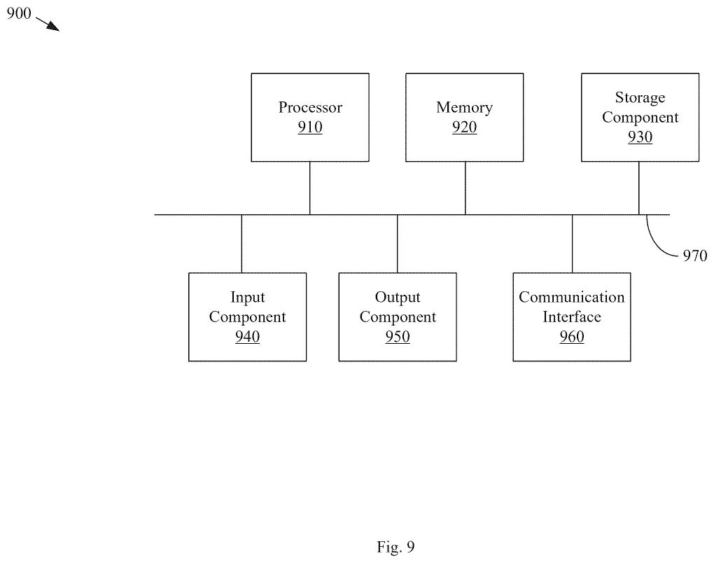

FIG. 9 is a block diagram of a device 900 according to at least one embodiment.

As shown in FIG. 9, the device 900 includes processor 910, a memory 920, a storage component 930, an input component 940, an output component 950, a communication interface 960, and a bus 970.

The processor 910, as used herein, means any type of computational circuit that may comprise hardware elements and software elements. The processor 910 may be embodied as a multi-core processor, a single core processor, or a combination of one or more multi-core processors and/or one or more single core processors, a distributed processing system, or the like. The processor 910 may be a Central Processing Unit (CPU), a graphics processing unit (GPU), an accelerated processing unit (APU), an application-specific integrated circuit (ASIC), or another type of processing component.

Memory 920 includes a non-transitory computer readable medium. Memory 920 includes a random-access memory (RAM), a read only memory (ROM), and/or another type of dynamic or static storage device (e.g., a flash memory, a magnetic memory, and/or an optical memory) that stores information and/or instructions for use by processor 910. The memory 920 comprises machine-readable instructions which are executable by the processor 910. These machine-readable instructions when executed by the processor 910 cause the processor 910 to perform one or more method steps of an embodiment described above.

Storage component 930 stores information and/or software related to the operation and use of the device 900. For example, storage component 930 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 940 is configured to receive information, such as user input. For example, the input component 940 may include, but not be limited to, a touch screen display, a keyboard, a keypad, a mouse, a button, a switch, and/or a microphone. Additionally, or alternatively, the input component 940 may include a sensor for sensing information (e.g., a global positioning system (GPS), an accelerometer, a gyroscope, and/or an actuator).

Output component 950 is configured to provide output information from the device 900. For example, the output component 950 may be, but not limited to, a display, a speaker, an instruction device to an external device, and/or one or more light-emitting diodes (LEDs).

Communication interface 960 is an interface that provides a communication connection to other devices, such as external devices and internal devices. The connection by the communication interface 960 can be a wired connection, a wireless connection, or a combination of wired and wireless connections, and can be a direct connection or an indirect connection via a communication network that exists between the device 900 and other devices. In other words, the standard of the communication interface 960 is not limited.

The bus 970 acts as an interconnect between the processor 910, the memory 920, the storage component 930, the input component 940, the output component 950, and the communication interface 960 of the device 900. The bus 970 may include a wired interconnection or a wireless interconnection.

The number and arrangement of components shown in FIG. 9 are provided as an example. In practice, device 900 may include additional components, fewer components, different components, or differently arranged components than those shown in FIG. 9. Additionally, or alternatively, a set of components (e.g., one or more components) of device 900 may perform one or more functions described as being performed by another set of components of device 900. Further, one or more method steps described in any of the embodiments may be performed utilizing a plurality of devices 900 in communication with one another.

At least one embodiment of the method provides an artificial intelligence (AI) based device for management of a network. The AI Based Network Management Device provides an AI Model that is trained to perform AI Based Network Management. At least one input is received for processing by a Trained AI Model of an AI Based Network Management Device. The at least one input is processed using the Trained AI Model for the AI Based Network Management Device to identify a Network Management Issue. Based on the processing the at least one input by the Trained AI Model of the AI Based Network Management Device, automatically addressing the Network Management Issue using the Trained AI Model of the AI Based Network Management Device. Information associated with the automatically addressed network management issue is provided to at least one user as output. The management of the network includes monitoring and analysis of International Roaming (IR) Key Performance Indicator (KPI) which measures the quality of service a mobile network user experiences in response to a user roaming on another network, e.g., in a different country. The AI Based Network Management Device is able to focus on metrics such as call setup success rate, dropped call rate, data connection quality, and overall network accessibility while roaming. In at least one embodiment, the AI Based Network Management Device automates IR tasks traditionally performed by international roaming engineers, thereby improving operational efficiency and resource optimization. In at least one embodiment, the AI Based Network Management Device performs testing, KPI measurement, comparison with benchmarks, troubleshooting, and ticket management. In at least one embodiment, the AI Based Network Management Device is usable for supporting other aspects of the business.

Embodiments described herein describe a method that provides one or more advantages. For example, the AI Based Network Management Device automates international roaming tasks. The AI Based Network Management Device automatically monitors and detects international roaming events. The AI Based Network Management Device receives input, such as user prompts and signaling obtained from the network. Based on the input, the AI Based Network Management Device then provides as output a response from a Chatbot. Other information provided as output includes VoIP communications, email messages, and ticketing.
[1] An aspect of this description is directed to a method including receiving at least one input for processing by a Trained AI Model of an AI Based Network Management Device, processing the at least one input using the Trained AI Model for the AI Based Network Management Device to identify a Network Management Issue, based on the processing the at least one input by the Trained AI Model of the AI Based Network Management Device, automatically addressing the Network Management Issue using the Trained AI Model of the AI Based Network Management Device, and providing, to at least one user, as output information associated with the automatically addressed network management issue.
[2] The method described in [1], further includes provisioning an Artificial Intelligence (AI) Model for an AI Based Network Management Device and providing network data to the AI Model to train the AI Model, wherein the network data is provided using data stored in a data platform.
[3] The method described in any of [1] to [2], wherein the receiving the at least one input includes receiving a verbal prompt provided by a user to a chatbot of the AI Based Network Management Device.
[4] The method described in any of [1] to [3], wherein the receiving the at least one input includes receiving data from systems implemented for monitoring the network.
[5] The method described in any of [1] to [4], wherein the information provided as output includes verbal output to a user via a chatbot of the AI Based Network Device.
[6] The method described in any of [1] to [5], wherein the providing the information as output includes providing test results, tracing outcomes, identification of anomalies, benchmarking, ticketing of issues, and reports.
[7] The method described in any of [1] to [6], wherein the providing the information as output includes providing verbal messages using a Voice over IP system, sending email messages using an email program, and generating tickets using an incident ticket system.
[8] An aspect of this description is directed to a system configured to receive at least one input for processing by a Trained AI Model of an AI Based Network Management Device; and process the at least one input using the Trained AI Model for the AI Based Network Management Device to identify a Network Management Issue. Based on the processing the at least one input by the Trained AI Model of the AI Based Network Management Device, the Trained AI Model of the AI Based Network Management Device automatically addresses the Network Management Issue. Information associated with the automatically addressed network management issue is provided as output to at least one user.
[9] The system described in [8], further configured to provision an Artificial Intelligence (AI) Model for an AI Based Network Management Device and to provide network data to the AI Model to train the AI Model, wherein the network data is provided using data stored in a data platform.
[10] The system described in any of [8] to [9], wherein the at least one input includes a verbal prompt provided by a user to a chatbot of the AI Based Network Management Device.
[11] The system described in any of [8] to [10], wherein the at least one input includes data received from systems implemented for monitoring the network.
[12] The system described in any of [8] to [11], wherein the information provided as output includes verbal output provided to a user via a chatbot of the AI Based Network Device.
[13] The system described in any of [8] to [12], wherein the information provided as output includes test results, tracing outcomes, identification of anomalies, benchmarking, ticketing of issues, and reports.
[14] The system described in any of [8] to [13], wherein the information provided as output includes providing verbal messages using a Voice over IP system, sending email messages using an email program, and generating tickets using an incident ticket system.
[15] An aspect of this description is directed to a non-transitory computer-readable media having computer-readable instructions stored thereon, which when executed perform operations for receiving at least one input for processing by a Trained AI Model of an AI Based Network Management Device and processing the at least one input using the Trained AI Model for the AI Based Network Management Device to identify a Network Management Issue. Based on the processing the at least one input by the Trained AI Model of the AI Based Network Management Device, the Network Management Issue is automatically addressed using the Trained AI Model of the AI Based Network Management Device. Information associated with the automatically addressed network management issue is provided, as output, to at least one user.
[16] The non-transitory computer-readable media described in [15], further including provisioning an Artificial Intelligence (AI) Model for an AI Based Network Management Device and providing network data to the AI Model to train the AI Model, wherein the network data is provided using data stored in a data platform.
[17] The non-transitory computer-readable media described in any of [15] to [16], wherein the receiving the at least one input includes receiving a verbal prompt provided by a user to a chatbot of the AI Based Network Management Device.
[18] The non-transitory computer-readable media described in any of [15] to [17], wherein the receiving the at least one input includes receiving data from systems implemented for monitoring the network.
[19] The non-transitory computer-readable media described in any of [15] to [18], wherein the information provided as output includes verbal output to a user via a chatbot of the AI Based Network Device.
[20] The non-transitory computer-readable media described in any of [15] to [19], wherein the providing the information as output includes providing test results, tracing outcomes, identification of anomalies, benchmarking, ticketing of issues, and reports, wherein the providing the information as output further includes providing verbal messages using a Voice over IP system, sending email messages using an email program, and generating tickets using an incident ticket system.

Separate instances of these programs can be executed on or distributed across any number of separate computer systems. Thus, although certain steps have been described as being performed by certain devices, software programs, processes, or entities, this need not be the case. A variety of alternative implementations will be understood by those having ordinary skill in the art.

Additionally, those having ordinary skill in the art readily recognize that the techniques described above can be utilized in a variety of devices, environments, and situations. Although the embodiments have been described in language specific to structural features or methodological acts, the subject matter defined in the appended claims is not necessarily limited to the specific features or acts described. Rather, the specific features and acts are disclosed as exemplary forms of implementing the claims.

What is claimed is:

1. A method comprising:
receiving at least one input for processing by a Trained AI Model of an AI Based Network Management Device;
processing the at least one input using the Trained AI Model for the AI Based Network Management Device to identify a Network Management Issue;
based on the processing the at least one input by the Trained AI Model of the AI Based Network Management Device, automatically addressing the Network Management Issue using the Trained AI Model of the AI Based Network Management Device; and
providing, to at least one user, as output information associated with the automatically addressed network management issue.

2. The method of claim 1 further comprises provisioning the AI Model for the AI Based Network Management Device and providing network data to the AI Model to train the AI Model, wherein the network data is provided using data stored in a data platform.

3. The method of claim 1, wherein the receiving the at least one input includes receiving a verbal prompt provided by a user to a chatbot of the AI Based Network Management Device.

4. The method of claim 1, wherein the receiving the at least one input includes receiving data from systems implemented for monitoring the network.

5. The method of claim 1, wherein the information provided as output includes verbal output to a user via a chatbot of the AI Based Network Device.

6. The method of claim 1, wherein the providing the information as output includes providing test results, tracing outcomes, identification of anomalies, benchmarking, ticketing of issues, and reports.

7. The method of claim 1, wherein the providing the information as output includes providing verbal messages using a Voice over IP system, sending email messages using an email program, and generating tickets using an incident ticket system.

8. A system configured to:
receive at least one input for processing by a Trained AI Model of an AI Based Network Management Device;
process the at least one input using the Trained AI Model for the AI Based Network Management Device to identify a Network Management Issue;
based on the processing the at least one input by the Trained AI Model of the AI Based Network Management Device, automatically address the Network Management Issue automatically addressed using the Trained AI Model of the AI Based Network Management Device; and
provide, to at least one user, as output, information associated with the automatically addressed network management issue.

9. The system of claim 8 further configured for provisioning the AI Model for the AI Based Network Management Device and providing network data to the AI Model to train the AI Model, wherein the network data is provided using data stored in a data platform.

10. The system of claim 8, wherein the at least one input includes a verbal prompt provided by a user to a chatbot of the AI Based Network Management Device.

11. The system of claim 8, wherein the at least one input includes data received from systems implemented for monitoring the network.

12. The system of claim 8, wherein the information provided as output includes verbal output provided to a user via a chatbot of the AI Based Network Device.

13. The system of claim 8, wherein the information provided as output includes test results, tracing outcomes, identification of anomalies, benchmarking, ticketing of issues, and reports.

14. The system of claim 8, wherein the information provided as output includes providing verbal messages using a Voice over IP system, sending email messages using an email program, and generating tickets using an incident ticket system.

15. A non-transitory computer-readable media having computer-readable instructions stored thereon, which when executed performs operations comprising:
receiving at least one input for processing by a Trained AI Model of an AI Based Network Management Device;
processing the at least one input using the Trained AI Model for the AI Based Network Management Device to identify a Network Management Issue;
based on the processing the at least one input by the Trained AI Model of the AI Based Network Management Device, automatically addressing the Network Management Issue using the Trained AI Model of the AI Based Network Management Device; and
providing, to at least one user, as output information associated with the automatically addressed network management issue.

16. The non-transitory computer-readable media of claim 15 further comprising provisioning the AI Model for the AI Based Network Management Device and providing network data to the AI Model to train the AI Model, wherein the network data is provided using data stored in a data platform.

17. The non-transitory computer-readable media of claim 15, wherein the receiving the at least one input includes receiving a verbal prompt provided by a user to a chatbot of the AI Based Network Management Device.

18. The non-transitory computer-readable media of claim 15, wherein the receiving the at least one input includes receiving data from systems implemented for monitoring the network.

19. The non-transitory computer-readable media of claim 15, wherein the information provided as output includes verbal output to a user via a chatbot of the AI Based Network Device.

20. The non-transitory computer-readable media of claim 15, wherein the providing the information as output includes providing test results, tracing outcomes, identification of anomalies, benchmarking, ticketing of issues, and reports, wherein the providing the information as output further includes providing verbal messages using a Voice over IP system, sending email messages using an email program, and generating tickets using an incident ticket system.
